(19) United States
(12) Patent Application Publication
(10) Pub. No.: US 2025/0020444 A1
(43) Pub. Date: Jan. 16, 2025

(54) SENSING DEVICE

(71) Applicant: LG INNOTEK CO., LTD., Seoul (KR)

(72) Inventor: Jong Yeop YANG, Seoul (KR)

(73) Assignee: LG INNOTEK CO., LTD., Seoul (KR)

(21) Appl. No.: 18/715,611

(22) PCT Filed: Jan. 2, 2023
(86) PCT No.: PCT/KR2023/000012

§ 371 Date: May 31, 2024

(30) Foreign Application Priority Data
Jan. 3, 2022 (KR) 10-2022-0000167

(51) Int. Cl. G01B 7/30; G01D 5/14

(52) U.S. Cl. CPC G01B 7/30; G01D 5/145

(57) ABSTRACT

Disclosed in an embodiment is a sensing device, comprising: a case; a rotor rotatably disposed inside the case; a stator arranged to correspond to the rotor; a main gear that rotates in conjunction with the stator; a sub-gear that rotates in conjunction with the main gear; a magnet disposed on the sub-gear; and a substrate including a sensor disposed to face the magnet, wherein the sub-gear comprises: a body having gear teeth formed on the outer circumference thereof; a first protrusion part formed on one surface of the body to protrude toward the substrate; and a second protrusion part formed to protrude from the other surface of the body, wherein an end of the first protrusion part is disposed in a groove formed in the substrate. Accordingly, the sensing device may improve measurement accuracy by guiding rotation of the sub-gear through a support structure offering rotational support and simultaneously preventing movement of the sub-gear such as tilting.

### TECHNICAL FIELD

The present embodiment relates to a sensing device.

### BACKGROUND ART

A steering system that assists steering using separate power may be used in a vehicle to ensure the stability of steering of the vehicle. In particular, an electronic power steering system (EPS) with low power loss and high accuracy may be used in the vehicle.

And, the electric power steering system enables a driver to drive safely by ensuring turning stability and providing a rapid restoring force using an electronic control unit that controls a motor according to driving conditions and driver operation information detected by a speed sensor, a torque sensor, an angle sensor, and the like.

In addition, the angle sensor measures a steering angle of a steering handle using a main gear which rotates in conjunction with the rotation of a rotor, a sub-gear engaged with the main gear to rotate, a magnet coupled to the sub-gear, a Hall IC which detects a change in magnetic force of the magnet, and the like.

However, when a center of the magnet fixed to the sub-gear and a center of the Hall IC disposed to correspond to the magnet are not accurately aligned, there is a problem in measuring an accurate steering angle.

In order to solve such a problem, the angle sensor uses a separate middle case which supports the sub-gear.

However, when the middle case is used, there is a problem of an increase in the size of the angle sensor.

In addition, there is a problem that interference occurs when the middle case and the angle sensor are arranged with other components.

In addition, since an assembly process of the middle case is added, the productivity is lowered, an assembly tolerance increases due to the middle case, and thus there is a problem of the reliability degradation of measurement precision.

Accordingly, development of a sensing device that is structurally improved to improve measurement precision of a steering angle even when the middle case is omitted from the angle sensor is being required.

### Technical Problem

The present embodiment is directed to providing a sensing device in which the measurement precision of a steering angle is improved through a support structure which rotatably supports a sub-gear without a middle case.

Objectives to be solved by embodiments are not limited to the objectives described above, and objectives which are not described above will be clearly understood by those skilled in the art from the following descriptions.

### Technical Solution

One aspect of the present invention provides a sensing device including a case, a rotor rotatably disposed in the case, a stator disposed to correspond to the rotor, a main gear which rotates in conjunction with the stator, a sub-gear which rotates in conjunction with the main gear, a magnet disposed on the sub-gear, and a substrate including a sensor disposed to face the magnet, wherein the sub-gear includes a body having an outer circumferential surface on which gear teeth are formed, a first protrusion part formed to protrude from one surface of the body toward the substrate, and a second protrusion part formed to protrude from the other surface of the body, and an end portion of the first protrusion part is disposed in a groove formed in the substrate.

Another aspect of the present invention provides a sensing device including a case including an upper case and a lower case, a stator disposed in the case, a rotor disposed inside the stator, a main gear which rotates in conjunction with the stator, a sub-gear which rotates in conjunction with the main gear, a magnet disposed on the sub-gear, and a substrate including a sensor disposed to correspond to the magnet, wherein a lower end of the sub-gear is in contact with the lower case, and an upper end of the sub-gear is disposed in contact with the substrate.

According to an embodiment, measurement precision can be improved by guiding rotation of a sub-gear and also preventing movement, such as tilting, of the sub-gear using a support structure.

Various useful advantages and effects of the embodiments are not limited to the above-described contents and will be more easily understood from descriptions of the specific embodiments.

### DESCRIPTION OF DRAWINGS

FIG. 1 is a perspective view illustrating a sensing device according to an embodiment.

FIG. 2 is a cross-sectional view illustrating the sensing device according to the embodiment.

FIG. 3 is a perspective view illustrating a lower case of the sensing device according to the embodiment.

FIG. 4 is a plan view illustrating the lower case of the sensing device according to the embodiment.

FIG. 5 is a perspective view illustrating a sub-gear in which a magnet of the sensing is disposed device according to the embodiment.

FIG. 6 is a perspective view illustrating the sub-gear in which the magnet of the sensing device is disposed according to the embodiment.

FIG. 7 is a front view illustrating the sub-gear in which the magnet of the sensing device is disposed according to the embodiment.

FIG. 8 is a plan view illustrating the sub-gear in which the magnet of the sensing device is disposed according to the embodiment.

FIG. 9 is a bottom view illustrating the sub-gear in which the magnet of the sensing device is disposed according to the embodiment.

FIG. 10 is a cross-sectional view illustrating the sub-gear in which the magnet of the sensing device is disposed according to the embodiment.

FIG. 11 is a cross-sectional view illustrating the sub-gear of the sensing device according to the embodiment.

FIG. 12 is a bottom perspective view illustrating a substrate of the sensing device according to the embodiment.

FIG. 13 is a bottom view illustrating the substrate of the sensing device according to the embodiment.

### Modes of the Invention

Hereinafter, embodiments will be described with reference to the accompanying drawings. However, the present invention is not limited to some embodiments which will be described and may be implemented in a variety of different forms, and one or more components of the embodiments may be selectively combined, substituted, and used.

In addition, when any one element is described as being formed or disposed “on” or “under” another element, such a description includes both a case in which the two elements are formed or disposed in direct contact with each other and a case in which one or more other elements are interposed between the two elements. In addition, when one element is described as being formed “on or under” another element, such a description may include a case in which the one element is formed at an upper side or a lower side with respect to another element.

Hereinafter, in the detailed description of the example embodiments of the invention with reference to the accompanying drawings, components that are the same or correspond to each other will be denoted by the same reference numerals in all of the figures, and redundant descriptions will be omitted.

A sensing apparatus according to an embodiment may be disposed between an output shaft (not shown) and an input shaft (not shown) of steering shafts. In this case, the output shaft may be called a first shaft, and the input shaft may be called a second shaft.

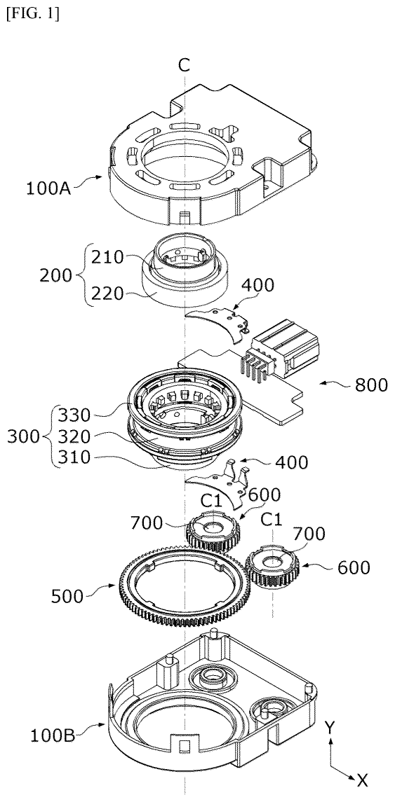

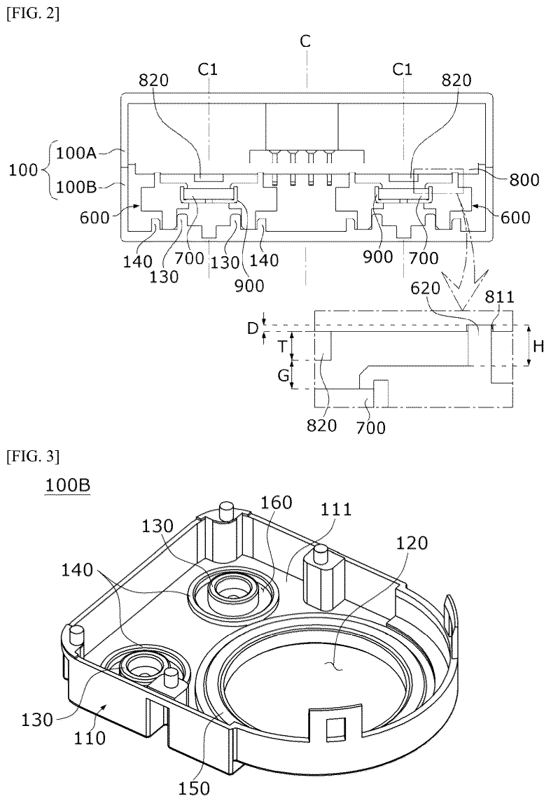

FIG. 1 is a perspective view illustrating the sensing device according to the embodiment, and FIG. 2 is a cross-sectional view illustrating the sensing device according to the embodiment. Here, an X direction illustrated in FIGS. 1 and 2 may be a radial direction, and a Y direction may be an axial direction. In addition, the axial direction and the radial direction may be perpendicular to each other. In addition, reference symbol “C” illustrated in FIGS. 1 and 2 may be a rotation center of a rotor 200, a stator 300, and a main gear 500. In addition, reference symbol “C1” illustrated in FIGS. 1 and 2 may be a rotation center of a sub-gear 600 and a magnet 700. In addition, “C” and “C1” may be parallel to each other in the axial direction.

Referring to FIGS. 1 and 2, the sensing device according to the embodiment may include a case 100 including an upper case 100A and a lower case 100B, the rotor 200 rotatably disposed in the case 100, the stator 300 disposed to correspond to the rotor 200, a collector 400 disposed to correspond to the stator 300, the main gear 500 which rotates in conjunction with the stator 300, the sub-gear 600 which rotates in conjunction with the main gear 500, the magnet 700 disposed on the sub-gear 600, and a substrate 800 including a sensor 820 disposed to correspond to the magnet 700. In this case, the main gear 500 may be referred to as a first gear, and the sub-gear 600 may be referred to as a second gear. In addition, the sensing device may include two sub-gears 600.

The sensing device can improve measurement precision of a steering angle using a support structure which rotatably supports the sub-gear 600.

In this case, the support structure may be formed on at least any one of the lower case 100B and the substrate 800.

For example, the measurement precision can be improved by minimizing movement due to rotation of the of the sub-gear 600 using a groove formed in the substrate 800 on which one end portion of the sub-gear 600 is disposed. In addition, the measurement precision can be improved by minimizing movement due to rotation of the sub-gear 600 using a support structure of the lower case 100B in which the other end portion of the sub-gear 600 is disposed.

In addition, the sensing device may further include a holder 900 for arrangement and protection of the magnet 700.

The case 100 may form an exterior of the sensing device.

The case 100 may include the upper case 100A and the lower case 100B coupled to form an accommodation space therein. In addition, the rotor 200, the stator 300, the collector 400, and the like may be disposed in the accommodation space.

In consideration of coupling of the input shaft and the rotor 200, a through hole may be formed in the upper case 100A.

FIG. 3 is a perspective view illustrating the lower case of the sensing device according to the embodiment, and FIG. 4 is a plan view illustrating the lower case of the sensing device according to the embodiment.

Referring to FIGS. 3 and 4, the lower case 100B may include a case body 110, a through hole 120 formed in the case body 110, and a first guide 130 and a second guide 140 formed to protrude from a lower surface 111 of the case body 110. In this case, the case body 110 may be referred to as a lower case body.

In addition, the lower case 110B may include a friction surface 150 in contact with the stator 300.

The case body 110 may be formed in a tube shape and formed of a synthetic resin material such as a plastic.

In consideration of coupling of the input shaft and the stator 300, the through hole 120 may be formed in the case body 110. In this case, the through hole 120 may be formed to pass through the case body 110 in the axial direction

The first guide 130 may guide rotation of the sub-gear 600.

The first guide 130 may be formed in a pipe shape and disposed in the sub-gear 600. In this case, a center of the first guide 130 may be coaxially disposed with a rotation center C1 of the sub-gear 600.

The second guide 140 may guide rotation of the sub-gear 600.

The second guide 140 may be formed in a pipe shape and disposed outside the sub-gear 600. In this case, a center of the second guide 140 may be coaxially disposed with the rotation center C1 of the sub-gear 600.

Meanwhile, the first guide 130 and the second guide 140 may be disposed to be spaced apart from each other around the rotation center C1 of the sub-gear 600. Accordingly, a groove 160 may be formed between the first guide 130 and the second guide 140, and a lower end portion of the sub-gear 600 may be disposed in the groove 160. In this case, the groove 160 may be referred to as a case groove.

That is, the first guide 130 and the second guide 140 may implement a support structure which rotatably supports the sub-gear 600 to prevent or minimize movement such as tilting occurring in the sub-gear 600.

In addition, the first guide 130 and the second guide 140 may be formed to have different heights based on the lower surface 111. Specifically, a protruding height of the first guide 130 may be greater than a protruding height of the second guide 140 based on the lower surface 111. Accordingly, the first guide 130 and the second guide 140 more stably guide rotation of the sub-gear 600 and may also improve the utilization of an internal space of the case 100.

The friction surface 150 may be in contact with one lower region of the stator 300.

In addition, the friction surface 150 may be formed at a predetermined axial height based on the lower surface 111.

In addition, a lubricating member may be applied onto the friction surface 150 to minimize a frictional force during rotation of the stator 300.

The rotor 200 may be rotatably disposed inside the stator 300. In addition, the rotor 200 may be connected to the second shaft which is the input shaft of the steering shaft. In addition, the input shaft may be a steering shaft connected to a handle of a vehicle. In this case, the term “inward” may refer to a direction toward a center C in the radial direction, and the term “outward” may refer to a direction opposite to “inward.”

The rotor 200 may include a first yoke 210 formed in a cylindrical shape and a magnet 220 disposed on the first yoke 210. In this case, the first yoke 210 and the magnet 220 may be coupled though a rotor holder. For example, the rotor holder may be formed of a synthetic resin such as a resin. Accordingly, the first yoke 210 and the magnet 220 may be coupled through the rotor holder using an insert injection method.

The first yoke 210 may be coupled to the second shaft. Accordingly, the first yoke 210 may rotate in conjunction with rotation of the second shaft. In this case, the first yoke 210 may be formed in a cylindrical shape or a pipe shape and formed of a metal material.

The magnet 220 may be disposed on an outer side of the first yoke 210. In this case, the magnet 220 may be fixedly attached to or press-fitted to an outer circumferential surface of the first yoke 210. In addition, the magnet 220 may be referred to as a rotor magnet or main magnet.

The stator 300 may be rotatably disposed outside the rotor 200. In addition, the stator 300 may be connected to the first shaft which is the output shaft.

The stator 300 may include a second yoke 310 connected to the output shaft, a stator body 320 disposed on one side of an outer circumferential surface of the second yoke 310, and a pair of stator teeth 330 disposed on the stator body 320.

The second yoke 310 may be connected to the first shaft which is the output shaft of the steering shaft. Accordingly, the second yoke 310 may rotate in conjunction with rotation of the first shaft. In this case, the second yoke 310 may be formed of a metal material but is not necessarily limited thereto. For example, the second yoke 310 may be formed of a different material with a predetermined strength or more so that the first shaft is fixedly press-fitted thereto.

The stator body 320 may be disposed on one end portion of the second yoke 310. For example, the stator body 320 may be disposed on one end portion of the second yoke 310 through an insert injection method using a synthetic resin such as a resin. In addition, the magnet 220 of the rotor 200 may be disposed in and spaced apart from the stator body 320.

In addition, the stator body 320 may include a hole formed to be coupled to the stator tooth 330.

The stator teeth 330 may be fixedly coupled to the stator body 320, In this case, the stator teeth 330 may be provided as the pair of stator teeth 330 to be disposed on and under the stator body 320. In this case, the stator teeth 330 may be referred to as stator rings.

In addition, the stator teeth 330 may include a plurality of teeth disposed to be spaced apart from each other along an inner circumferential surface of the stator body 320, and the teeth may be disposed to correspond to the magnet 220. For example, the teeth may be disposed outside the magnet 220 in the radial direction.

The collector 400 allows a torque sensor (not shown) disposed on the substrate 800 to detect a change in magnetic force generated due to a rotation difference according to torsion between the input shaft and the output shaft. In this case, the collector 400 may be formed of a metal material and fixed to the case 100.

Two collectors 400 may be disposed to correspond to the pair of stator teeth 230 to collect a flux of the stator 300. In this case, the collectors 400 may be divided into an upper collector and a lower collector according to an arrangement location.

The main gear 500 may be disposed to operate in conjunction with rotation of the stator 300. For example, the main gear 500 may be coupled to the stator body 320 of the stator 300 and may rotate in conjunction with rotation of the stator 300.

The main gear 500 may be formed in a ring shape and a plurality of gear teeth may be formed on an outer circumferential surface thereof. In addition, the gear teeth of the main gear 500 may be engaged with gear teeth of the sub-gear 600.

The sub-gear 600 may rotate in conjunction with rotation of the main gear 500. For example, the sub-gear 600 may be engaged with the main gear 500. In this case, the sub-gear 600 may be disposed to have the rotation center C1 different from that of the main gear 500.

In order to improve the measurement precision of the steering angle, the sensing device may include the two sub-gears 600. In this case, the two sub-gears 600 are both disposed to be engaged with the main gear 500 but are not necessarily limited thereto. For example, one of the sub-gears 600 may be disposed to be engaged with the other sub-gear 600 that is different from the main gear 500.

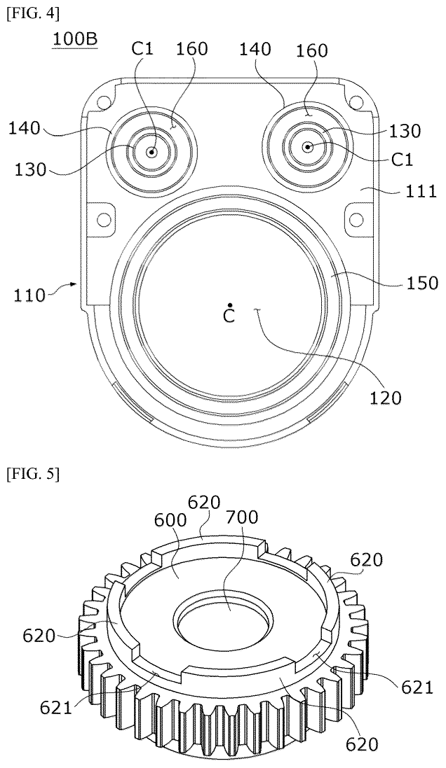

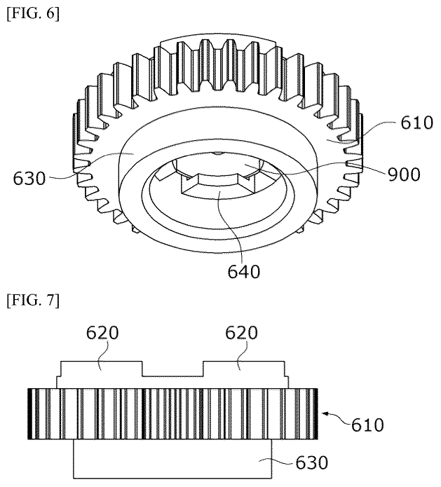

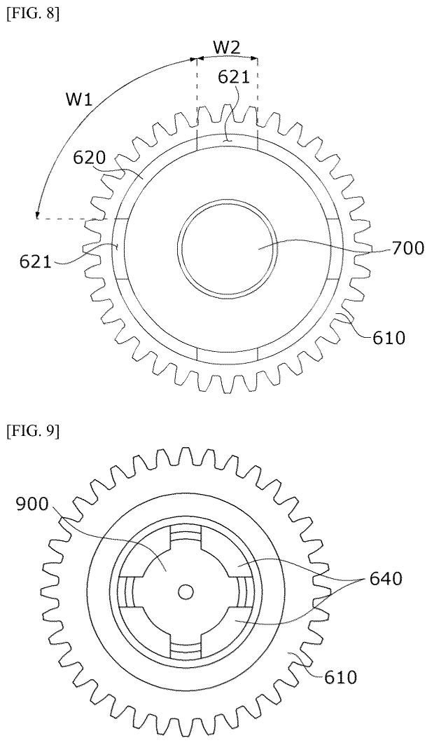

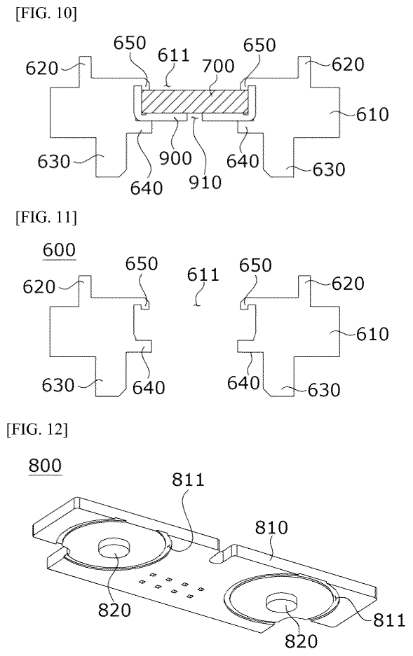

FIG. 5 is a perspective view illustrating the sub-gear in which a magnet of the sensing device is disposed according to the embodiment, and FIG. 6 is a perspective view illustrating the sub-gear in which the magnet of the sensing device is disposed according to the embodiment. FIG. 7 is a front view illustrating the sub-gear in which the magnet of the sensing device is disposed according to the embodiment, and FIG. 8 is a plan view illustrating the sub-gear in which the magnet of the sensing device is disposed according to the embodiment. FIG. 9 is a bottom view illustrating the sub-gear in which the magnet of the sensing device is disposed according to the embodiment, and FIG. 10 is a cross-sectional view illustrating the sub-gear in which the magnet of the sensing device is disposed according to the embodiment. FIG. 11 is a cross-sectional view illustrating the sub-gear of the sensing device according to the embodiment.

Referring to FIGS. 5 to 11, a magnet 700 may be disposed in the sub-gear 600. In this case, the holder 900 may be disposed to surround the magnet 700 excluding an upper surface of the magnet 700.

The sub-gear 600 may include a body 610 in which a hole 611 is formed in a central portion, a first protrusion part 620 formed to protrude from an upper surface which is one surface of the body 610 toward the substrate 800, and a second protrusion part 630 formed to protrude from a lower surface which is the other surface of the body 610 toward the lower case 100B.

In addition, the sub-gear 600 may include a first supporting part 640 and a second supporting part 650 which support the holder 900 coupled to the magnet 700. In this case, the body 610, the first protrusion part 620, the second protrusion part 630, the first supporting part 640, and the second supporting part 650 may be integrally formed.

The body 610 may include gear teeth formed on an outer circumferential surface thereof to be engaged with the gear teeth of the main gear 500.

In addition, the magnet 700 may be disposed in the body 610. Accordingly, the magnet 700 may rotate in conjunction with rotation of the sub-gear 600.

In addition, the body 610 may include the hole 611 formed to pass therethrough in the axial direction to expose the upper surface of the magnet 700. Accordingly, the magnet 700 may be disposed to face the sensor 820 through the hole 611.

In this case, the sub-gear 600 allows constant measurement precision of the sensing device to be maintained by maintaining a constant separation gap G between the magnet 700 and the sensor 820 using the hole 611 and the first protrusion part 620. Specifically, even when an end portion of the first protrusion part 620 is disposed in the groove 811, the sensing device may secure the separation gap G using the hole 611. In this case, the separation gap G may be referred to as a gap.

For example, even when the sub-gear 600 rotates, since the first protrusion part 620 is in contact with the substrate 800 and the second protrusion part 630 is in contact with the lower case 100B, the separation gap G between the magnet 700 and the sensor 820 may be maintained constant. Accordingly, the sensing device can maintain the constant measurement precision.

The first protrusion part 620 may be formed to protrude from the body 610 in the axial direction to have a predetermined height H. In this case, an upper end portion of the first protrusion part 620 may be disposed in the groove 811 formed in the substrate 800. Accordingly, rotation of the sub-gear 600 may be guided by the groove 811.

In this case, the height H is formed greater than an axial thickness T of the sensor 820 to form the separation gap G.

Meanwhile, a lubricating member may be disposed in the groove 811, and an internal pressure thereof may increase when an internal space of the first protrusion part 620 is sealed by the lubricating member. In addition, when the sub-gear 600 rotates, a burst sound or damage can occur due to a pressure difference between the internal space and the outside.

Accordingly, the first protrusion part 620 may be provided as a plurality of protrusions disposed to be spaced apart from each other in a circumferential direction to solve the problem. Specifically, the problem can be solved by preventing the occurrence of the pressure difference using a path 621 formed between the protrusions.

The protrusion may be formed to have a predetermined circumferential width W1. In addition, the path 621 may be formed to have a predetermined circumferential width W2. In this case, the circumferential width W1 of the protrusion may be greater than the circumferential width W2 of the path 621. In this case, the circumferential width W1 of the protrusion may be referred to as a first width, and the circumferential width W2 of the path 621 may be referred to as a second width.

Meanwhile, the plurality of protrusions may be rotationally symmetrically disposed. Accordingly, the path 621 may also be provided as a plurality of paths 621 to be rotationally symmetrical. Accordingly, a pressure difference occurring when the sub-gear 600 rotates may be prevented using the paths 621 so that the sub-gear 600 is level and is not biased to one side.

The second protrusion part 630 may be formed in a pipe shape.

In addition, the second protrusion part 630 may be in contact with the lower surface 111 of the lower case 100B. In this case, the second protrusion part 630 may be disposed in the groove 160 formed between the first guide 130 and the second guide 140 and may be guided by the first guide 130 and the second guide 140.

The first supporting part 640 and the second supporting part 650 prevent the magnet 700 from being separated from the sub-gear 600. Specifically, the first supporting part 640 and the second supporting part 650 may prevent the separation of the magnet 700 by supporting an upper portion and a lower portion of the holder 900 coupled to the magnet 700.

In this case, since the holder 900 coupled to the magnet 700 may be disposed in the sub-gear 600 through an insert injection method, the holder 900 coupled to the magnet 700 may be disposed between the first supporting part 640 and the second supporting part 650 in the axial direction.

The first supporting part 640 and the second supporting part 650 may be formed to protrude inward from the body 610. In this case, a reference of the radial direction may be the rotation center C1 of the sub-gear 600.

The magnet 700 may be disposed in the sub-gear 600 and formed in a cylindrical shape.

In this case, the magnet 700 may be coupled to the sub-gear 600 through an insertion injection molding method. Accordingly, the magnet 700 may share the rotation center C1 with the sub-gear 600 and rotate in conjunction with rotation of the sub-gear 600. In this case, the magnet 700 may be referred to as an angle magnet or sub-magnet.

In addition, the magnet 700 may include the upper surface disposed to face the sensor 820. In addition, the upper surface may be disposed to have the separation gap G from the sensor 820.

The substrate 800 may be disposed on the sub-gear 600. In addition, the substrate 800 may be in contact with the sub-gear 600 to support the sub-gear 600. In this case, the substrate 800 may be disposed outside the stator body 320. In this case, the substrate 800 may be a printed circuit board.

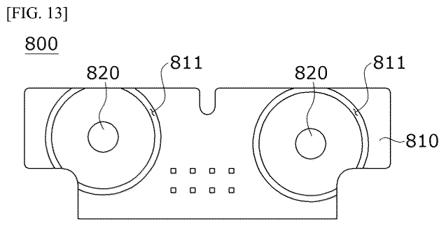

FIG. 12 is a bottom perspective view illustrating the substrate of the sensing device according to the embodiment, and FIG. 13 is a bottom view illustrating the substrate of the sensing device according to the embodiment.

Referring to FIGS. 12 and 13, the substrate 800 may include a substrate body 810 and the sensor 820 disposed on the substrate body 810. In addition, the substrate 800 may include a torque sensor (not shown) capable of detecting torque in addition to the sensor 820. In this case, the sensor 820 and the torque sensor may be Hall ICs. In addition, the torque sensor may be disposed on the substrate 800 to correspond to the collector 400.

The substrate body 810 may be formed in a flat plate shape and include the groove 811 concavely formed in a lower surface thereof.

In addition, since the end portion of the first protrusion part 620 is disposed in the groove 811, the groove 811 may guide rotation of the first protrusion part 620.

In addition, the groove 811 may be formed to have a predetermined depth D. In this case, in consideration of the separation gap G, the sum of the depth D of the groove 811 and the axial thickness T of the sensor 820 may be smaller than the height H of the first protrusion part 620.

The sensor 820 may be disposed to correspond to the magnet 700 to detect a change in magnetic field of the magnet 700. For example, one surface of the sensor 820 may be disposed to face the upper surface of the magnet 700.

In addition, the sensor 820 may be formed to have the predetermined axial thickness T and disposed on a lower surface of the substrate 800.

In addition, the number of sensors 820 corresponding to the number of magnets 700 may be disposed on the substrate 800.

Meanwhile, the groove may be omitted from the substrate 800. Accordingly, the first protrusion part 620 of the sub-gear 600 may also be disposed in contact with the lower surface of the substrate 800 to prevent or minimize movement of the sub-gear 600.

The holder 900 may be formed to surround the magnet 700.

In addition, in consideration of detection of the sensor 820, the holder 900 may be formed in a cylindrical shape in which an opening is formed at one side thereof. Accordingly, the magnet 700 may be disposed in the holder 900.

In addition, the magnet 700 may be fixed in the holder 900 by an adhesive member such as a bond. In this case, when the magnet 700 is inserted into the holder 900, an internal pressure of the holder 900 increases due to the adhesive member, and thus a problem that the magnet 700 cannot be seated in the holder 900 can occur. In order to solve such a problem, a hole 910 may be formed in the holder 900.

While the present invention has been described above with reference to the exemplary embodiments, it may be understood by those skilled in the art that various modifications and changes of the present invention may be made within a range not departing from the spirit and scope of the present invention defined by the appended claims.

### REFERENCE NUMERALS

100: CASE, 200: ROTOR, 300: STATOR, 400: COLLECTOR, 500: MAIN GEAR, 600: SUB-GEAR, 610: BODY, 611: HOLE, 620: FIRST PROTRUSION PART, 630: SECOND PROTRUSION PART, 700: MAGNET, 800: SUBSTRATE, 820: SENSOR, 900: HOLDER

1.-16. (canceled)

17. A sensing device comprising:
a case including an upper case and a lower case;
a rotor rotatably disposed in the case;
a stator disposed to correspond to the rotor;
a main gear which rotates in conjunction with the stator;
a sub-gear which rotates in conjunction with the main gear and is supported by the lower case;
a magnet disposed on the sub-gear; and
a substrate including a sensor disposed to face the magnet,
wherein the sub-gear is provided with a first protrusion part protruding toward the substrate, and
wherein a groove is formed in the substrate to accommodate an end portion of the first protrusion part.

18. The sensing device of claim 17, wherein the first protrusion part is provided as a plurality of protrusions disposed to be spaced apart from each other in a circumferential direction, and
wherein paths are formed between the protrusions.

19. The sensing device of claim 18, wherein a lubricating member is provided in the groove.

20. The sensing device of claim 19, wherein the paths are rotationally symmetrically formed with respect to a center of the sub-gear.

21. The sensing device of claim 17, wherein the sub-gear further includes a body having an outer circumferential surface on which gear teeth are formed and a second protrusion part formed to protrude from the body,
wherein the second protrusion part is formed in a pipe shape, and
wherein a hole is formed to communicate with an inner portion of the second protrusion part in the body.

22. The sensing device of claim 21, wherein the magnet is disposed to face the sensor through the hole.

23. The sensing device of claim 21, wherein the lower case includes a first guide and a second guide which are formed to protrude from a lower surface thereto, and
wherein a lower end portion of the second protrusion part is disposed between the first guide and the second guide which are disposed to be spaced apart from each other.

24. The sensing device of claim 23, wherein a height of the first guide is greater than a height of the second guide based on the lower surface.

25. The sensing device of claim 22, wherein a sum of a depth (D) of the groove and an axial thickness (T) of the sensor is smaller than a height (H) of the first protrusion part.

26. The sensing device of claim 17, further comprising a holder formed in a tube shape in which an opening is formed at one side thereof,
wherein the magnet is disposed in the holder.

27. The sensing device of claim 26, wherein the first supporting part and the second supporting part are disposed to be spaced apart from each other in an axial direction.

28. The sensing device of claim 27, wherein a hole is formed in the holder.

29. A sensing device comprising:
a case including an upper case and a lower case;
a stator disposed in the case;
a rotor disposed inside the stator;
a main gear which rotates in conjunction with the stator;
a sub-gear which rotates in conjunction with the main gear;
a holder disposed on the sub-gear;
a magnet disposed in the holder; and
a substrate including a sensor disposed to correspond to the magnet,
wherein an opening is formed at one side the holder,
wherein a lower end of the sub-gear is supported by the lower case, and
wherein an upper end of the sub-gear is disposed in contact with the substrate.

30. The sensing device of claim 29, wherein the sub-gear includes:
a body having an outer circumferential surface on which gear teeth are formed;
a first protrusion part formed to protrude from one surface of the body toward the substrate; and
a second protrusion part formed to protrude from the other surface of the body, and
wherein an end portion of the first protrusion part is in contact with the substrate.

31. The sensing device of claim 29, wherein the sub-gear includes:
a body having an outer circumferential surface on which gear teeth are formed; and
a first protrusion part formed to protrude from one surface of the body toward the substrate,
wherein an end portion of the first protrusion part is in contact with the substrate, and
wherein the magnet is disposed to face the sensor through a hole formed in the body.

32. The sensing device of claim 31, wherein a sum of a depth (D) of the groove and an axial thickness (T) of the sensor is smaller than a height (H) of the first protrusion part.
